(19) United States
(12) Patent Application Publication
(10) Pub. No.: US 2026/0101132 A1
(43) Pub. Date: Apr. 9, 2026

(54) SPEAKER BOX ASSEMBLY

(71) Applicant: Harman International Industries, Incorporated, Stamford, CT (US)

(72) Inventors: Xiang ZHANG, Shenzhen (CN); Shuangju WEI, Shenzhen (CN)

(73) Assignee: Harman International Industries, Incorporated, Stamford, CT (US)

(21) Appl. No.: 19/346,477

(22) Filed: Sep. 30, 2025

(30) Foreign Application Priority Data
Oct. 8, 2024 (CN) 202411391890.3

(51) Int. Cl. H04R 1/02; H04R 1/28; H04R 7/18

(52) U.S. Cl. CPC H04R 1/025; H04R 1/2803; H04R 7/18

(57) ABSTRACT

A speaker box assembly having a speaker box housing that is cylindrically constructed and includes a circumferentially surrounding housing wall and an end opening defined by the housing wall. The speaker box housing has at least one diaphragm assembly including a diaphragm unit and a diaphragm surround surrounding the diaphragm unit. The diaphragm assembly is supported in the speaker box housing by a at least one basket device, where the basket device includes a conical section and an end section. An outer edge of the end section extends to an inner wall of the housing wall, wherein the basket device is arranged in the end opening of the speaker box housing in a form-fitting manner by means of the end section. The end section constitutes a heat dissipation surface for releasing heat generated during operation of the speaker box assembly to an environment.

### CROSS REFERENCE

Priority is claimed to application serial no. 202411391890.3, filed October 8, 2024, in China, the disclosure of which is incorporated in its entirety by reference.

### TECHNICAL FIELD

The present disclosure relates to a speaker box assembly.

### BACKGROUND

A speaker box apparatus includes a housing and a loudspeaker unit, a horn assembly, and other components arranged in the housing. During normal operation of the speaker box apparatus, particularly during high-power operation, a significant amount of heat is typically generated. If the heat continuously accumulates and cannot be released to the environment, it will lead to overheating of the speaker box apparatus, abnormal surface temperature, and consequently result in unstable operational states of the speaker box apparatus, or even cause failure of the speaker box apparatus.

To dissipate heat from the speaker box apparatus, fans or ventilation holes are typically provided in the speaker box apparatus, thereby releasing the heat generated during operation to the external environment through convection. However, for closed-type speaker box apparatuses, and particularly for subwoofers requiring a compact design, it is difficult to dissipate heat by providing fans or ventilation holes.

### SUMMARY OF THE INVENTION

In view of the aforementioned drawback, the technical problem to be solved by the present disclosure lies in providing a speaker box apparatus with improved thermal performance.

To solve the aforementioned technical problem, the present disclosure relates to a speaker box assembly. The speaker box assembly includes:

a speaker box housing, the speaker box housing being cylindrically constructed and including a circumferentially surrounding housing wall and an end opening defined by the housing wall;

at least one diaphragm assembly, the diaphragm assembly including a diaphragm unit and a diaphragm surround surrounding the diaphragm unit; and

at least one basket device, the diaphragm assembly being supported in the speaker box housing by means of the basket device,

where the basket device includes a conical section and an end section, where an outer edge of the end section extends to an inner wall of the housing wall, thereby causing the basket device to be arranged in the end opening of the speaker box housing in a form-fitting manner by means of the end section, where the end section constitutes a heat dissipation surface for releasing heat generated during operation of the speaker box assembly to an environment.

According to one or more embodiments of the present disclosure, the diaphragm surround is arranged at the end opening.

According to one or more embodiments of the present disclosure, in a cross-section defined by the end opening, an area ratio of the end section of the basket device to the cross-section is at least 0.4.

According to one or more embodiments of the present disclosure, the area ratio of the end section of the basket device to the cross-section is at least 0.5.

According to one or more embodiments of the present disclosure, the end section of the basket device extends perpendicular to the housing wall of the speaker box housing.

According to one or more embodiments of the present disclosure, the end section of the basket device extends inclinedly relative to the housing wall of the speaker box housing.

According to one or more embodiments of the present disclosure, the speaker box assembly includes an annularly constructed trim ring, the end section being secured by means of the trim ring from a side of the end section facing the end opening.

According to one or more embodiments of the present disclosure, an outer edge of the trim ring is engaged in an end face of the housing wall.

According to one or more embodiments of the present disclosure, the trim ring is pressed against the end section.

According to one or more embodiments of the present disclosure, the outer edge of the end section of the basket device is bent away from the end opening, where the basket device is supported on the housing wall of the speaker box housing by means of the bent outer edge.

According to one or more embodiments of the present disclosure, a sealing member is arranged between the outer edge and the housing wall.

According to one or more embodiments of the present disclosure, the sealing member includes foam.

According to one or more embodiments of the present disclosure, the basket device is constructed in multiple parts.

According to one or more embodiments of the present disclosure, the conical section and the end section are connected to each other by means of threaded connection, riveting or welding.

According to one or more embodiments of the present disclosure, the basket device is constructed in one piece.

According to one or more embodiments of the present disclosure, the basket device is produced through casting.

According to one or more embodiments of the present disclosure, the basket device is made of metal.

According to one or more embodiments of the present disclosure, the speaker box assembly is constructed as a subwoofer.

### BRIEF DESCRIPTION OF THE DRAWINGS

In order to more clearly illustrate the technical solutions of the embodiments of the present disclosure, the drawings of the embodiments will be briefly introduced below. Apparently, the drawings in the following description only relate to some embodiments of the present disclosure, rather than limiting the present disclosure.

FIG. 1 schematically illustrates a perspective view of a speaker box assembly according to the present disclosure;

FIG. 2 schematically illustrates an exploded view of the speaker box assembly according to the present disclosure;

FIG. 3 illustrates a combined view of a basket device and a diaphragm assembly according to the present disclosure viewed from a front oblique perspective;

FIG. 4 illustrates a combined view of the basket device and the diaphragm assembly of the present disclosure viewed from a rear oblique perspective;

FIG. 5 schematically illustrates a disassembled view of a basket device and a diaphragm assembly according to an implementation of the present disclosure;

FIG. 6 schematically illustrates a combined view of the basket device and the diaphragm assembly shown in FIG. 5;

FIG. 7 schematically illustrates a partial perspective view of the speaker box assembly according to the present disclosure; and

FIG. 8 schematically illustrates an enlarged cross-sectional view of Region A in FIG. 7.

### DETAILED DESCRIPTION

Embodiments of the present invention will be described in detail below. Examples of the embodiments are shown in the accompanying drawings, where the same or similar reference numerals always indicate the same or similar elements or elements with the same or similar functions. The embodiments described below with reference to the accompanying drawings are illustrative, which are only used to explain the present invention, and cannot be construed as limitations to the present invention.

Unless otherwise defined, the technical terms or scientific terms used here should have the ordinary meanings understood by those of ordinary skill in the field of the present disclosure. In the description of the present disclosure, it should be understood that an orientation or positional relationship indicated by the terms "center," "longitudinal," "lateral," "upper," "lower," "front," "back," "left," "right," "vertical," "horizontal," "top," "bottom," "inner," "outer," etc. is an orientation or positional relationship shown based on the accompanying drawings, is only for the convenience of describing the present disclosure and simplifying the description, rather than indicating or implying that a device or element referred to must have a specific orientation or be constructed and operated in a specific orientation, and thus cannot be understood as a limitation to the present disclosure. In addition, the terms “first” and “second” are used for descriptive purposes only, and cannot be construed as indicating or implying relative importance.

A speaker box assembly is provided according to the present disclosure. The speaker box assembly includes: a speaker box housing, the speaker box housing being cylindrically constructed and including a circumferentially surrounding housing wall and an end opening defined by the housing wall; at least one diaphragm assembly, the diaphragm assembly including a diaphragm unit and a diaphragm surround surrounding the diaphragm unit; and at least one basket device, the diaphragm assembly being supported in the speaker box housing by means of the basket device, where the basket device includes a conical section and an end section, where an outer edge of the end section extends to an inner wall of the housing wall, thereby causing the basket device to be arranged in the end opening of the speaker box housing in a form-fitting manner by means of the end section, where the end section constitutes a heat dissipation surface for releasing heat generated during operation of the speaker box assembly to an environment.

In the prior art, an end section of a basket device is often designed as a standard component, which is constructed as an annular segment with a relatively small width, where an end-facing surface is additionally provided between this annular section and a circumferential wall of the speaker box housing. A radially inner edge of the end section of the basket device adjoins an outer edge of the diaphragm, and a radially outer edge thereof is, for example, connected to the end-facing surface of the speaker box housing by a plurality of additionally provided bolts. However, this design approach has poor thermal performance. That is, its heat dissipation performance is poor. Compared with the design of the prior art, the end section of the basket device of the present disclosure extends with its outer edge to an inner wall of the housing wall, thereby causing the area of the end section to be increased to such an extent that it can be arranged in the end opening of the speaker box housing in a form-fitting manner. Consequently, the area of the end section is significantly increased, such that it can provide a sufficiently large heat dissipation surface, and heat generated during operation of the speaker box assembly can be released to the external environment through this heat dissipation surface.

According to one or more embodiments of the present disclosure, the diaphragm surround is arranged at the end opening. In this way, the diaphragm surround, together with the end section of the basket device, covers the end opening of the speaker box housing.

According to one or more embodiments of the present disclosure, in a cross-section defined by the end opening, an area ratio of the end section of the basket device to the cross-section is at least 0.4. Preferably, the area ratio of the end section of the basket device to the cross-section is at least 0.5. Experiments show that when the area ratio of the end section of the basket device in the aforementioned cross-section is at least 0.4, preferably at least 0.5, it provides a sufficiently large heat dissipation surface, and furthermore provides a channel inside the speaker box housing that allows unimpeded heat transfer to the end opening, thereby ensuring a good heat dissipation effect.

According to one or more embodiments of the present disclosure, the end section of the basket device extends perpendicular to the housing wall of the speaker box housing. Alternatively, the end section of the basket device extends inclinedly relative to the housing wall of the speaker box housing.

According to one or more embodiments of the present disclosure, the speaker box assembly includes an annularly constructed trim ring, the end section being secured by means of the trim ring from a side of the end section facing the end opening.

According to one or more embodiments of the present disclosure, an outer edge of the trim ring is engaged in an end face of the housing wall. To this end, the outer edge of the trim ring may include snap pins, and correspondingly, snap grooves capable of accommodating the snap pins are provided in the end face of the housing wall. When the snap pins are engaged in the snap grooves, the trim ring closely surrounds the end opening of the speaker box housing, thereby preventing the basket device from disengaging from the end opening.

According to one or more embodiments of the present disclosure, the trim ring is pressed against the end section. By means of the pressing of the trim ring on the end section, the fixation of the basket device is further reliably ensured. For this purpose, connection between the trim ring and the end section may additionally be achieved by means of riveting, threaded connection, or the like.

According to one or more embodiments of the present disclosure, the outer edge of the end section of the basket device is bent away from the end opening, where the basket device is supported on the housing wall of the speaker box housing by means of the bent outer edge. When the basket device is installed in the speaker box housing, the outer edge of its end section that is in a bent configuration abuts against the inner wall of the housing wall in a pre-stressed manner, thereby achieving tight contact between the basket device and the speaker box housing.

According to one or more embodiments of the present disclosure, a sealing member is arranged between the outer edge and the housing wall.

According to one or more embodiments of the present disclosure, the sealing member includes foam. As an alternative, other materials suitable as a sealing member may also be considered, for example, rubber or silicone.

According to one or more embodiments of the present disclosure, the basket device is constructed in multiple parts.

According to one or more embodiments of the present disclosure, the conical section and the end section are connected to each other by means of threaded connection, riveting or welding.

In such an implementation, the requirements for the thermal performance of the speaker box assembly can be met.

According to one or more embodiments of the present disclosure, the basket device is constructed in one piece.

As a preferred implementation, a basket device constructed in one piece has more advantages compared to a basket device constructed in multiple parts. On the one hand, the basket device constructed in one piece eliminates the need for components required for mutual connection between the end section and the conical section, such as screws and rivets, thereby saving material costs and reducing installation steps and additional labor hours. On the other hand, the basket device constructed in one piece has better mechanical stability and sealing properties.

According to one or more embodiments of the present disclosure, the basket device is made of metal. Metal has good thermal conductivity, which facilitates heat dissipation, thereby ensuring favorable thermal performance of the speaker box assembly.

According to one or more embodiments of the present disclosure, the speaker box assembly is constructed as a subwoofer.

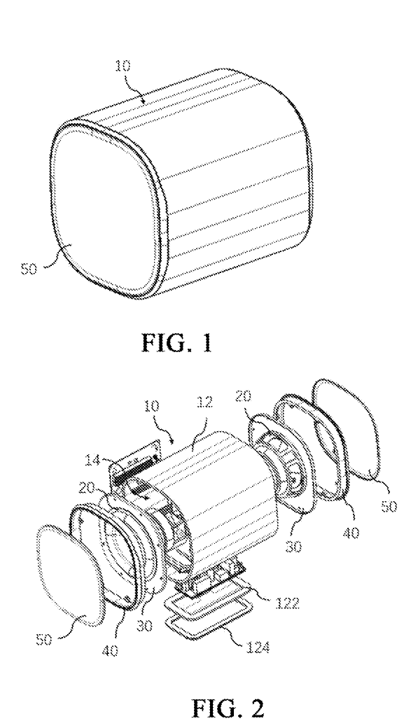

FIG. 1 schematically illustrates an external perspective view of a speaker box assembly constructed as a subwoofer. FIG. 2 schematically illustrates an exploded view of the speaker box assembly.

The speaker box assembly includes a speaker box housing 10, two diaphragm assemblies 20, correspondingly two basket devices 30, metal grilles 50 arranged at both ends of the speaker box assembly, and trim rings 40 arranged between the metal grilles 50 and the basket devices 30. Each diaphragm assembly 20 is supported in a respective one of the basket devices 30 and is installed in the speaker box housing 10 by means of the basket device 30.

Certainly, the speaker box assembly may also include only one diaphragm assembly 20 and one basket device 30 adapted thereto. For the sake of brevity, the following description is provided with respect to only one of the diaphragm assemblies 20 and one of the basket devices 30.

The speaker box housing 10 is cylindrically constructed and it includes a circumferentially surrounding housing wall 12 and an end opening 14 defined by the housing wall 12. Since the basket device 30 provides a good heat dissipation method, the speaker box housing 10 is allowed to be made of materials other than metal, for example, being made of plastic. In the housing wall 12 of the speaker box housing 10, a bottom cover 122 and a plastic support base 124 that is arranged outside the bottom cover 122 and supports the speaker box housing 12 are provided.

A PCB mainboard and a power supply board are arranged in the speaker box housing 10, which are constructed and operate in a known manner and will not be described in detail herein.

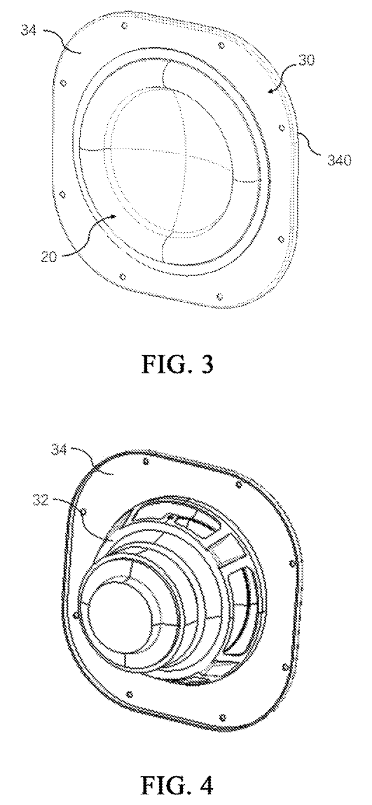

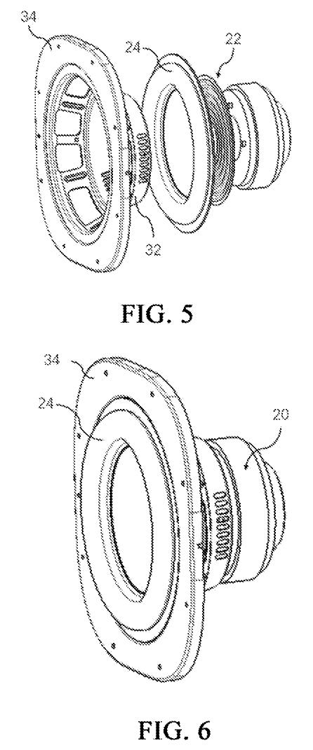

Furthermore, the basket device 30 is arranged in the speaker box housing 10. The basket device 30 may be made of metal, thereby possessing good conductivity. In the preferred implementation shown in FIG. 3 to FIG. 6, the basket device 30 is constructed in one piece and includes a conical section 32 and an end section 34. When viewed in a direction from the end opening 14 of the speaker box housing 10 toward the interior of the speaker box housing 10, a cross-section of the conical section 32 gradually narrows, and a circumferential surface of the conical section 32 is constructed in a hollowed-out manner. A radially inner edge of the end section 34 is connected to an edge of the conical section 32 facing the end opening 14, thereby forming an accommodation portion for the diaphragm assembly 20 together with the conical section 32. As shown in FIG. 5, the diaphragm assembly 20 includes a diaphragm unit 22 and a diaphragm surround 24 surrounding the diaphragm unit 22. The diaphragm unit 22 is substantially completely embedded in the aforementioned accommodation portion of the basket device 30, thereby extending axially within an inner cavity enclosed by the housing wall 12. As shown in FIG. 6, the diaphragm surround 24 is arranged in the end opening 14 and extends slightly beyond the end section 34 of the basket device 30. A radial outer edge of the end section 34 extends to an inner wall of the housing wall 12, thereby covering the end opening 14 of the speaker box housing 10 by means of the end section 34 and the diaphragm surround 24. The end section 34 of the basket device 30 may extend perpendicular to an axial direction of the speaker box housing 10. In a cross-section defined by the end opening 14, a ratio of the area of the end section 34 to a total area of the cross-section of the end opening 14 is at least 0.4, preferably at least 0.5. Compared with the prior art, the end section 34 not only serves to support the diaphragm assembly 20, but also functions as a heat dissipation surface due to its significantly increased interface with the external environment and its good thermal conductivity.

In an embodiment not shown, the basket device 30 may also be constructed in multiple parts. That is, it includes an independent conical section 32 and an independent end section 34, where the conical section 32 and the end section 34 are fixedly connected to each other by means of a plurality of bolts.

More preferably, the basket device 30 as shown in the figures is constructed in one piece, where the conical section 32 and the end section 34 are constructed as an integral whole by means of, for example, casting.

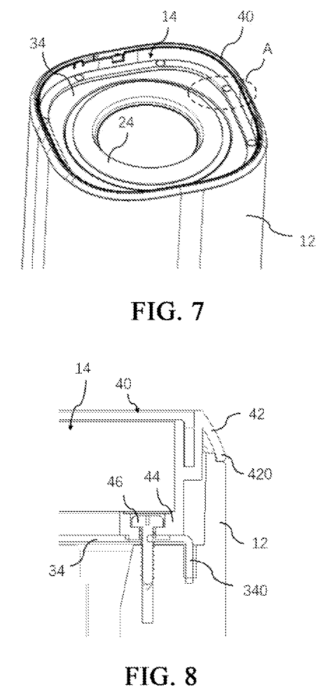

As shown in FIG. 7 and FIG. 8, the end section 34 of the basket device 30 is bent at its outer edge 340 away from the end opening 14, where the basket device 30 is supported on the housing wall 12 of the speaker box housing 10 by means of the bent outer edge 340. A sealing member is arranged between the outer edge 340 of the end section 34 and the housing wall 12, where the sealing member is made of foam.

The trim ring 40 is constructed as a whole in an annular shape. As particularly shown in FIG. 8, the trim ring 40 includes a shoulder 42 constructed in a stepped shape in a radial direction and a crimping portion 44. The trim ring 40 is pressed against the end section 34 of the basket device 30 from a side of the end section 34 facing the end opening 14, that is, from an outer side relative to the speaker box housing 10, where a free end 420 of the shoulder 42 is bent downward toward a side of the speaker box housing 10, thereby engaging with the speaker box housing 10. To ensure a firm snap-fit effect, a snap groove capable of accommodating the free end 420 is correspondingly constructed in an end face of the housing wall 12; and the crimping portion 44 abuts against the end section 34 of the basket device 30. To further ensure reliable connection, a fixing hole may be provided on the end section 34, and a fastener arranged on the crimping portion 44, for example, a screw 46, is screwed into the fixing hole, thereby firmly connecting the basket device 30 in the speaker box housing 10 by means of the trim ring 40.

Certain features, structures, or characteristics of one or more embodiments of the present disclosure may be appropriately combined.

The present disclosure may be implemented in the following manners:

Item 1: A speaker box assembly, including:

a speaker box housing, the speaker box housing being cylindrically constructed and including a circumferentially surrounding housing wall and an end opening defined by the housing wall;

at least one diaphragm assembly, the diaphragm assembly including a diaphragm unit and a diaphragm surround surrounding the diaphragm unit; and

at least one basket device, the diaphragm assembly being supported in the speaker box housing by means of the basket device,

where the basket device includes a conical section and an end section, where an outer edge of the end section extends to an inner wall of the housing wall, thereby causing the basket device to be arranged in the end opening of the speaker box housing in a form-fitting manner by means of the end section, where the end section constitutes a heat dissipation surface for releasing heat generated during operation of the speaker box assembly to an environment.

Item 2: The speaker box assembly according to item 1, wherein the diaphragm surround is arranged at the end opening.

Item 3: The speaker box assembly according to item 1 or 2, wherein in a cross-section defined by the end opening, an area ratio of the end section of the basket device to the cross-section is at least 0.4.

Item 4: The speaker box assembly according to any one of items 1 to 3, wherein the area ratio of the end section of the basket device to the cross-section is at least 0.5.

Item 5: The speaker box assembly according to any one of items 1 to 4, wherein the end section of the basket device extends perpendicular to the housing wall of the speaker box housing.

Item 6: The speaker box assembly according to any one of items 1 to 5, wherein the end section of the basket device extends inclinedly relative to the housing wall of the speaker box housing.

Item 7: The speaker box assembly according to any one of items 1 to 6, wherein the speaker box assembly includes an annularly constructed trim ring, the end section being secured by means of the trim ring from a side of the end section facing the end opening.

Item 8: The speaker box assembly according to any one of items 1 to 7, wherein an outer edge of the trim ring is engaged in an end face of the housing wall.

Item 9: The speaker box assembly according to any one of items 1 to 8, wherein the trim ring is pressed against the end section.

Item 10: The speaker box assembly according to any one of items 1 to 9, wherein the outer edge of the end section of the basket device is bent away from the end opening, where the basket device is supported on the housing wall of the speaker box housing by means of the bent outer edge.

Item 11: The speaker box assembly according to any one of items 1 to 10, wherein a sealing member is arranged between the outer edge and the housing wall.

Item 12: The speaker box assembly according to any one of items 1 to 11, wherein the sealing member includes foam.

Item 13: The speaker box assembly according to any one of items 1 to 12, wherein the basket device is constructed in multiple parts.

Item 14: The speaker box assembly according to any one of items 1 to 13, wherein the conical section and the end section are connected to each other by means of threaded connection, riveting or welding.

Item 15: The speaker box assembly according to any one of items 1 to 14, wherein the basket device is constructed in one piece.

Item 16: The speaker box assembly according to any one of items 1 to 15, wherein the basket device is produced through casting.

Item 17: The speaker box assembly according to any one of items 1 to 16, wherein the basket device is made of metal.

Item 18: The speaker box assembly according to any one of items 1 to 17, wherein the speaker box assembly is constructed as a subwoofer.

The foregoing is a description of the present disclosure and should not be considered a limitation thereof. Although several exemplary embodiments of the present disclosure are described, it will be readily understood by those skilled in the art that many modifications can be made to the exemplary embodiments without departing from the novel teachings and advantages of the present disclosure. Accordingly, all such modifications are intended to be encompassed within the scope of the present disclosure as defined by the claims. It should be understood that the foregoing is a description of the present disclosure and should not be considered to be limited to the particular embodiments as disclosed, and that modifications to the disclosed embodiments, as well as other embodiments, are intended to be included within the scope of the present disclosure.

1. A speaker box assembly, comprising:
a speaker box housing, the speaker box housing being cylindrically constructed and comprising a circumferentially surrounding housing wall and an end opening defined by the housing wall;
at least one diaphragm assembly, the diaphragm assembly comprising a diaphragm unit and a diaphragm surround surrounding the diaphragm unit; and
at least one basket device, the diaphragm assembly being supported in the speaker box housing by means of the basket device,
wherein the basket device comprises a conical section and an end section, wherein an outer edge of the end section extends to an inner wall of the housing wall, thereby causing the basket device to be arranged in the end opening of the speaker box housing in a form-fitting manner by means of the end section (34), wherein the end section constitutes a heat dissipation surface for releasing heat generated during operation of the speaker box assembly to an environment.

2. The speaker box assembly according to claim 1, wherein the diaphragm surround is arranged at the end opening.

3. The speaker box assembly according to claim 2, wherein in a cross-section defined by the end opening, an area ratio of the end section of the basket device to the cross-section is at least 0.4.

4. The speaker box assembly according to claim 3, wherein the area ratio of the end section of the basket device to the cross-section is at least 0.5.

5. The speaker box assembly according to claim 1, wherein the end section of the basket device extends perpendicular to the housing wall of the speaker box housing.

6. The speaker box assembly according to claim 1, wherein the end section of the basket device extends inclinedly relative to the housing wall of the speaker box housing.

7. The speaker box assembly according to claim 1, wherein the speaker box assembly comprises an annularly constructed trim ring, the end section being secured by means of the trim ring from a side of the end section facing the end opening.

8. The speaker box assembly according to claim 7, wherein an outer edge of the trim ring is engaged in an end face of the housing wall.

9. The speaker box assembly according to claim 7, wherein the trim ring is pressed against the end section.

10. The speaker box assembly according to claim 1, wherein the outer edge of the end section of the basket device is bent away from the end opening, wherein the basket device is supported on the housing wall of the speaker box housing by means of the bent outer edge.

11. The speaker box assembly according to claim 10, wherein a sealing member is arranged between the outer edge and the housing wall.

12. The speaker box assembly according to claim 11, wherein the sealing member comprises foam.

13. The speaker box assembly according to claim 1, wherein the basket device is constructed in multiple parts.

14. The speaker box assembly according to claim 13, wherein the conical section and the end section (34) are connected to each other by means of threaded connection, riveting or welding.

15. The speaker box assembly according to claim 1, wherein the basket device is constructed in one piece.

16. The speaker box assembly according to claim 15, wherein the basket device is produced through casting.

17. The speaker box assembly according to claim 1, wherein the basket device is made of metal.

18. The speaker box assembly according to claim 1, wherein the speaker box assembly is constructed as a subwoofer.
